(19) United States
(12) Patent Application Publication
(10) Pub. No.: US 2008/0114602 A1
(43) Pub. Date: May 15, 2008

(54) NORITEK, VOICE TYPE

(76) Inventor: HERMAN NORRIS, Perris, CA (US)

Correspondence Address: HERMAN NORRIS, 18867 ALEXANDER ST., PERRIS, CA, 92570, US

(21) Appl. No.: 11/279,544

(22) Filed: Nov. 10, 2006

(51) Int. Cl. G10L 21/06

(52) U.S. Cl. 704/271; 704/E15.001

(57) ABSTRACT

The VT-2000 is a portable communication device, that enables hearing and speaking impaired persons, to communicate to anyone who wants to talk to them.

The VT-2000, uses “voice recognition” and “text to speech” technology, in a “portable” hand carried unit, with dual view screens, email and text messaging capabilities.

The VT-2000 is a personal handheld device, that makes it possible for hearing and or speaking impaired persons to carry-on a normal conversation, with anyone willing to talk to them.

The VT-2000 uses “Windows CE” personal device software, running a voice recognition, and text to speech programming. The impaired person reads the text displayed on his screen via voice recognition, then types the response which is displayed for reading by the other person.

The opposing view screens allows both parties to view all communications.

### DRAWINGS

FIG. 1. Top View of “VT-2000”

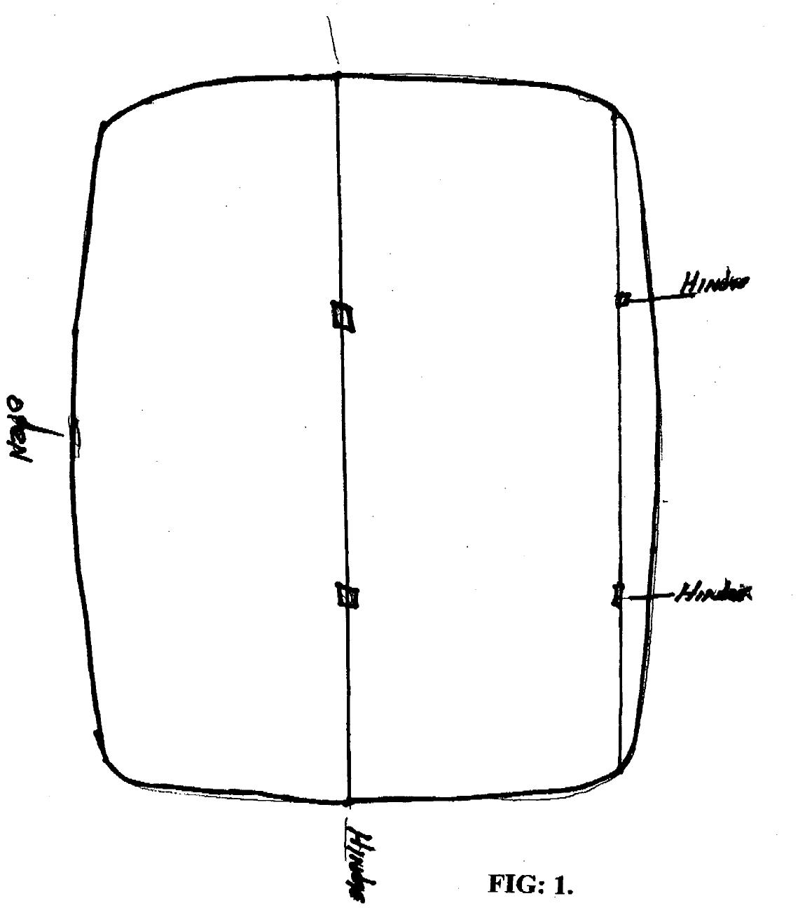

FIG. 2. Side View of “VT-2000” In Closed position.

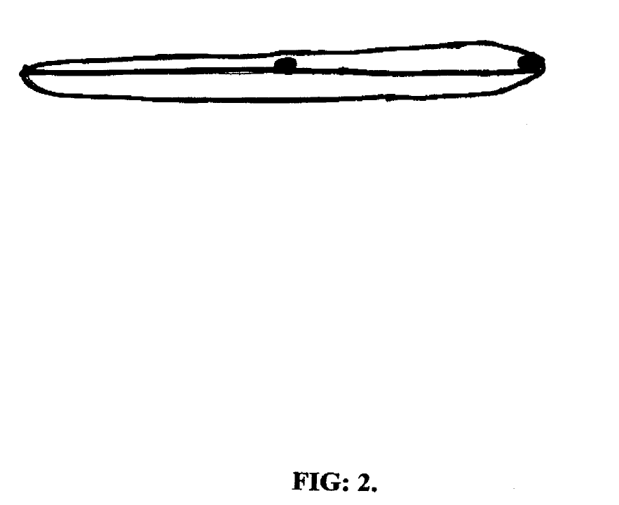

FIG. 3. Side View of “VT-2000” With flip screen in start, position.

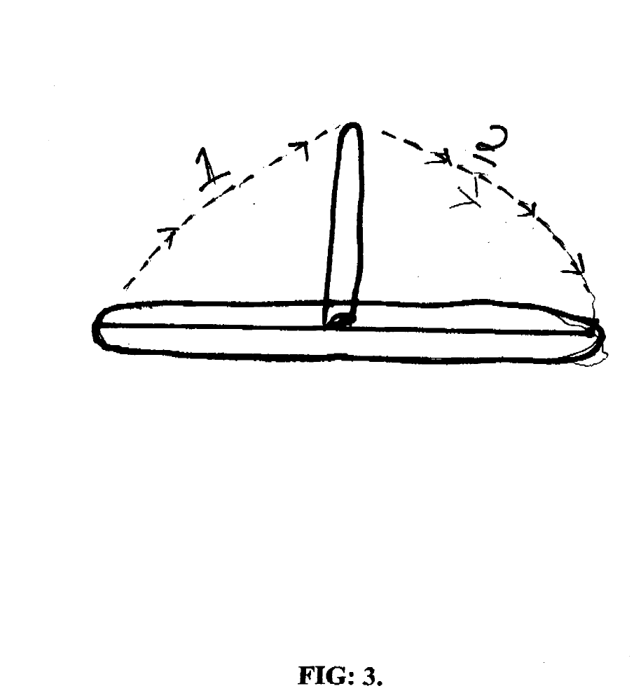

FIG. 4. Side View of “VT-2000” With flip screen in run, position.

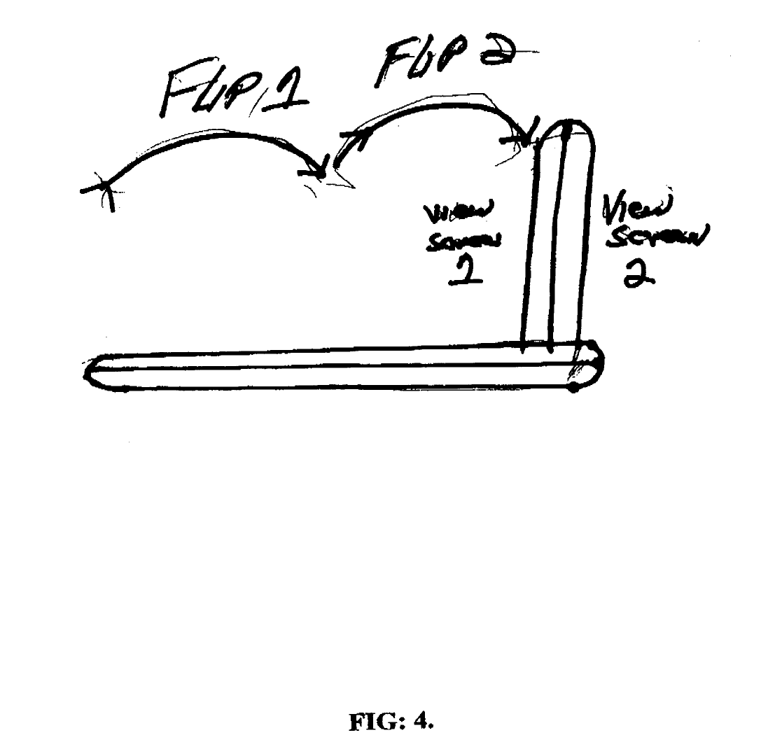

I claim:

1. That the “Noritek, VT-2000”, is a portable communication device, that enables hearing and speaking impaired persons, to communicate to anyone willing to talk to them “without” sign language.

2. That the specific merging of voice recognition and speech to text technology in the VT-2000 provides a high level of communication between persons with or without a hearing or speaking impairment.
